(19) United States
(12) Patent Application Publication
(10) Pub. No.: US 2018/0180972 A1
(43) Pub. Date: Jun. 28, 2018

(54) LENS DRIVING DEVICE, CAMERA MODULE, AND CAMERA-EQUIPPED APPARATUS

(71) Applicants: Taishi SUGIURA, Tokyo (JP); Tomohiko OSAKA, Tokyo (JP)

(72) Inventors: Taishi SUGIURA, Tokyo (JP); Tomohiko OSAKA, Tokyo (JP)

(73) Assignee: MITSUMI ELECTRIC CO., LTD., Tokyo (JP)

(21) Appl. No.: 15/580,876

(22) PCT Filed: Jun. 6, 2016
(86) PCT No.: PCT/JP2016/002728

§ 371 Date: Dec. 8, 2017

(30) Foreign Application Priority Data
Jun. 11, 2015 (JP) 2015-118287

(51) Int. Cl. G03B 13/36; H02K 41/035; H04N 5/225

(52) U.S. Cl. CPC G03B 13/36; H02K 1/02; H04N 5/2254; H02K 41/0354

(57) ABSTRACT

Provided are a lens driving device, a camera module, and a camera-equipped apparatus. A lens driving device according to the present invention includes an auto-focus coil, an auto-focus magnet, and a yoke. By utilizing a driving force of a voice coil motor constituted of the auto-focus coil and the auto-focus magnet, the lens driving device moves an auto-focus movable unit, which includes the auto-focus coil, along an optical axis direction, relative to an auto-focus fixed unit including the auto-focus magnet and the yoke, to achieve automatic focusing. The yoke has a side frame on which the auto-focus magnet is fixed; a top frame projecting inward from the top edge of the side frame, and eaves projecting to a region above the auto-focus coil in regions of the top frame except the four corners thereof.

### TECHNICAL FIELD

The present invention relates to an auto-focusing lens driving device, and to a camera module and a camera-mounted device that have an autofocus function.

### BACKGROUND ART

In general, a small-sized camera module is mounted in mobile terminals such as smartphones. A lens driving device having an autofocus function of automatically performing focusing during capturing a subject (hereinafter referred to as “AF (Auto Focus) function”) is applied in such a camera module (see e.g. Patent Literature (hereinafter referred to as “PTL”) 1 and PTL 2).

The auto-focusing lens driving device includes, for example, an auto-focusing coil (hereinafter referred to as “AF coil”) disposed at the periphery of a lens part, an auto-focusing magnet (hereinafter referred to as “AF magnet”) disposed to be radially spaced apart from the AF coil, and an elastic supporting part (for example, plate spring) for elastically supporting an autofocus movable part (hereinafter referred to as “AF movable part”) including the lens part and the AF coil, for example, with respect to an autofocus fixing part (hereinafter referred to as “AF fixing part”) including the AF magnet. Auto-focusing is performed by moving the AF movable part with respect to the AF fixing part in the optical-axis direction by utilizing a driving force of a voice coil motor composed of the AF coil and the AF magnet. In the meanwhile, the AF fixing part may include the AF coil and the AF movable part may include the AF magnet.

Lens driving devices disclosed in PTLS 1 and 2 are each provided with a yoke which forms a magnetic circuit together with an AF magnet, and this yoke serves as a casing of the lens driving device. In addition, the yoke is formed such that the inner peripheral edge of top frame of the yoke entirely projects inward in order to increase the thrust of the AF voice coil motor, and an opposite yoke portion is provided at a position facing the AF magnet with the AF coil therebetween.

### CITATION LIST

### Patent Literature

PTL 1
Japanese Patent Application Laid-Open No. 2014-016572
PTL 2
Japanese Patent Application Laid-Open No. 2014-225042

### SUMMARY OF INVENTION

### Technical Problem

In mobile terminals, such as smartphones, the weight of a camera module has tended to be thought lightly of since the proportion of the weight of the camera module is not significantly high in the weight of a mobile terminal. That is, although the weight reduction may be resulted from miniaturization and/or height reduction of the camera module, no consideration has been positively made to achieve the weight reduction of the camera module.

However, when a camera module is mounted in wearable terminals (terminals capable of being worn directly, such as wrist watches and glasses) which have attracted attention these days, the weight of the camera module cannot be disregarded, and it is required to positively reduce the weight of the camera module (for example, to a weight of 1/2 of the weight of camera module of traditional mobile terminals or less).

An object of the present invention is to provide a lightweight lens driving device having a high power-to-weight ratio (thrust (driving force) per total weight), a camera module, and a camera-mounted device.

### Solution to Problem

A lens driving device according to the present invention includes an auto-focusing coil to be disposed at a periphery of a lens part; one or more auto-focusing magnets to be disposed such that the one or more auto-focusing magnets are radially spaced apart from the auto-focusing coil and surround four sides of the auto-focusing coil; and a yoke for forming a magnetic circuit together with the one or more auto-focusing magnets, the lens driving device being configured to automatically perform focusing by moving an autofocus movable part with respect to an autofocus fixing part in an optical-axis direction by utilizing a driving force of a voice coil motor, the autofocus fixing part including the one or more auto-focusing magnets and the yoke, the autofocus movable part including the auto-focusing coil, the voice coil motor being composed of the auto-focusing coil and the one or more auto-focusing magnets. In the lens driving device, the yoke includes a side frame to which the one or more auto-focusing magnets are fixed, a top frame projecting inward from an upper edge of the side frame, and an eaves portion projecting over the auto-focusing coil from a portion of the top frame other than four corners of the top frame.

A camera module according to the present invention includes the lens driving device as described above, the lens part to be mounted to an autofocus movable part, and an image capturing part configured to capture a subject image imaged by the lens part.

A camera-mounted device according to the present invention is an information device or a transporting device, and includes the camera module as described above.

### Advantageous Effects of Invention

According to the present invention, it is possible to provide a lightweight lens driving device which has a high power-to-weight ratio by virtue that the weight of a yoke is reduced remarkably in comparison with traditional yokes while ensuring the mechanical strength of the yoke required as a casing and the thrust required for driving a lens.

### BRIEF DESCRIPTION OF DRAWINGS

FIG. 1 illustrates a wearable terminal in which a camera module according to an embodiment of the present invention is mounted;

FIG. 2 is a perspective view of an external appearance of the camera module;

FIG. 3 is an exploded perspective view of a lens driving device as seen from above;

FIG. 4 is an exploded perspective view of the lens driving device as seen from below;

FIG. 5 is a plan view illustrating a state where an AF coil is placed to a lens holder;

FIG. 6 is a sectional view of the lens driving device taken along the YZ plane; and

FIGS. 7A and 7B illustrate an automobile as a camera-mounted device in which an in-vehicle camera module is mounted.

### DESCRIPTION OF EMBODIMENTS

In the following, an embodiment of the present invention is described in detail with reference to the drawings.

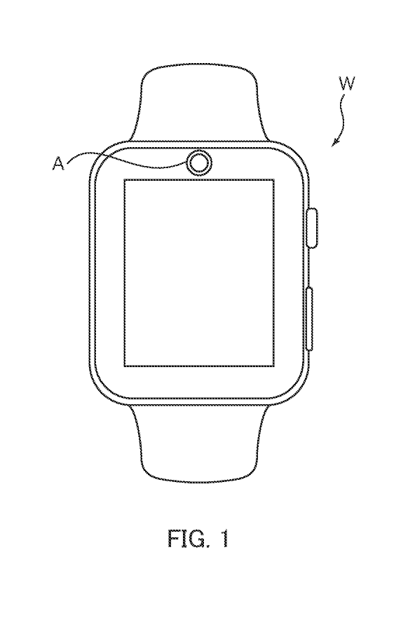

FIG. 1 illustrates wearable terminal W (camera-mounted device) in which camera module A according to the embodiment of the present invention is mounted. Camera module A has an autofocus function, and automatically performs focusing during capturing a subject.

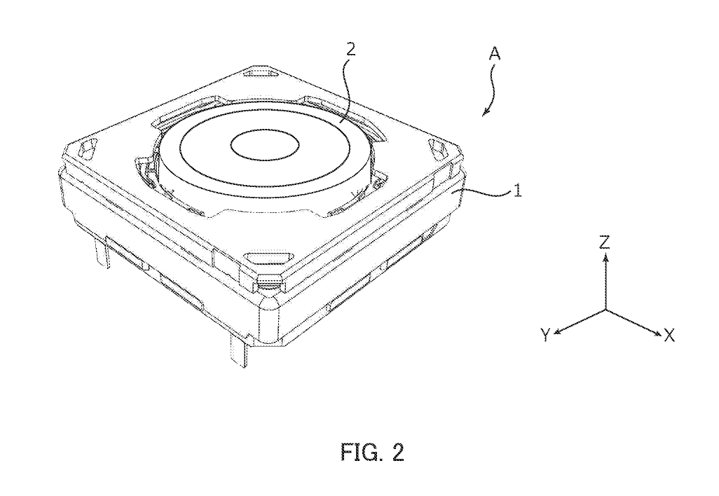

FIG. 2 is a perspective view of an external appearance of camera module A. As illustrated in FIG. 2, descriptions will be given for the present embodiment with an orthogonal coordinate system (X, Y, Z). In below-mentioned figures, descriptions will also be given with the orthogonal coordinate system (X, Y, Z). Camera module A is mounted such that the front-rear direction is the Z direction during actually capturing an image with wearable terminal W. That is, the Z direction is the optical-axis direction, the upper side in the figures is the light reception side in the optical-axis direction (also referred to as “macro position side”), and the lower side is the image formation side in the optical-axis direction (also referred to as “infinity position side”). In addition, the X and Y directions orthogonal to the Z-axis are referred to as “optical-axis orthogonal directions.”

Camera module A includes lens part 2 composed of a cylindrical lens barrel and a lens housed therein, AF lens driving device 1, an image capturing part (not illustrated) configured to capture a subject image imaged by lens part 2, and the like.

The image capturing part (not illustrated) includes an imaging device (not illustrated), and is disposed on the image formation side of lens driving device 1 in the optical-axis direction. The imaging device (not illustrated) is composed of, for example, a CCD (charge-coupled device) image sensor, a CMOS (complementary metal oxide semiconductor) image sensor, or the like. The imaging device (not illustrated) captures a subject image imaged by lens part 2.

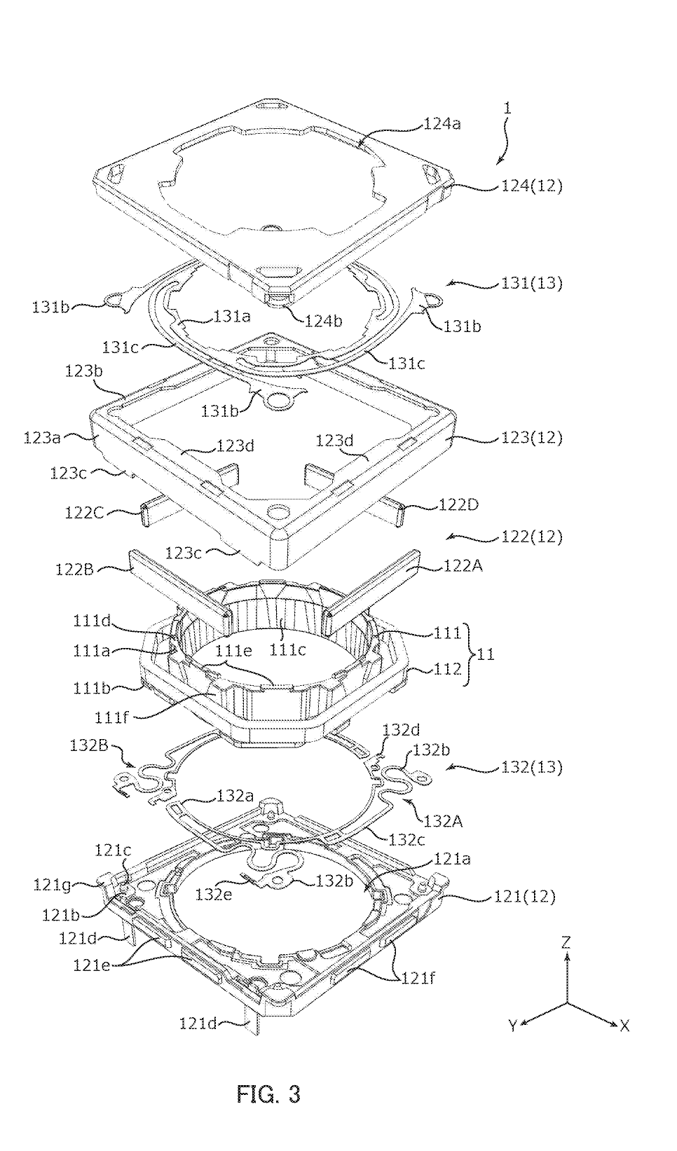

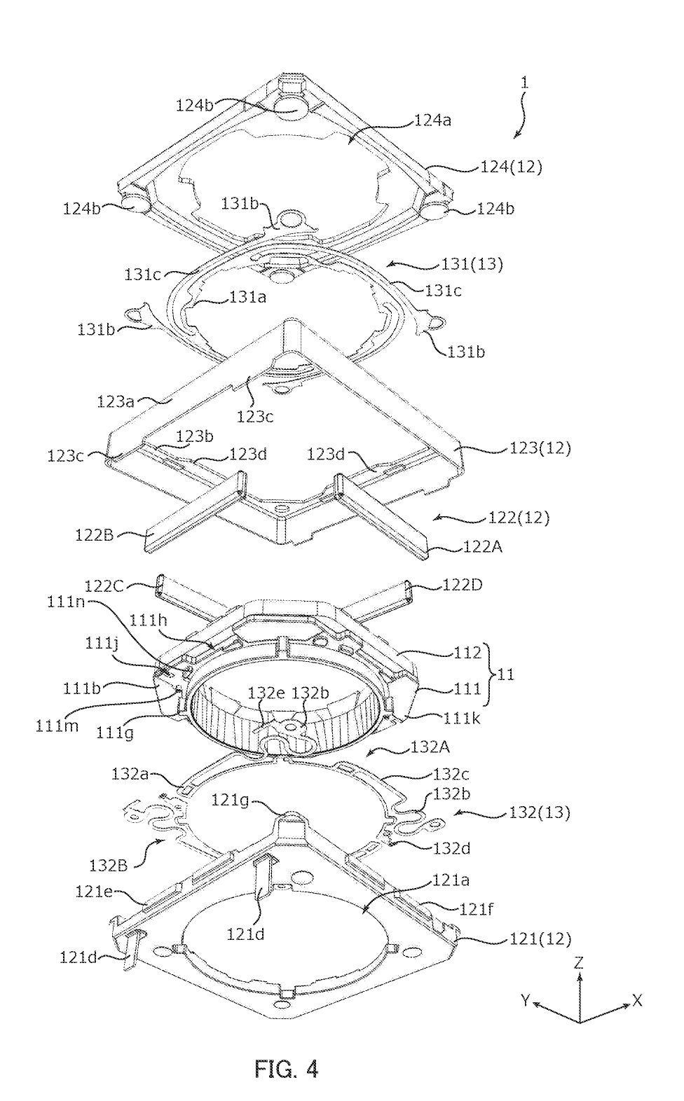

FIGS. 3 and 4 are an exploded perspective view of lens driving device 1. FIG. 3 is the upper exploded perspective view seen from the light reception side in the optical-axis direction, and FIG. 4 is the lower exploded perspective view seen from the image formation side in the optical-axis direction. As illustrated in FIGS. 3 and 4, lens driving device 1 includes AF movable part 11, AF fixing part 12, elastic supporting part 13, and the like. AF movable part 11 is disposed to be radially inwardly spaced apart from AF fixing part 12, and is coupled with AF fixing part 12 by elastic supporting part 13.

AF movable part 11 includes a coil being a component of an AF voice coil motor, and moves in the optical-axis direction during focusing. AF fixing part 12 includes a magnet being a component of the AF voice coil motor. That is, the moving-coil system is employed in lens driving device 1.

In the present embodiment, AF movable part 11 is composed of lens holder 111 and AF coil 112. AF fixing part 12 is composed of base 121, AF magnet part 122, yoke 123, and cover 124. Elastic supporting part 13 is composed of upper elastic supporting part 131 and lower elastic supporting part 132.

Lens holder 111 includes cylindrical lens housing 111a and flange portion 111b protruding radially outward from lens housing 111a.

Lens part 2 (see FIG. 2) is fixed to inner peripheral surface 111c of lens housing 111a adhesively or by screwing. Upper elastic supporting part 131 is fixed to upper surface 111d of lens housing 111a (hereinafter referred to as “upper-spring fixing portion 111d”). Upper-spring fixing portion 111d includes positioning pieces 111e protruding on the light reception side in the optical-axis direction. Upper elastic supporting part 131 is positioned by positioning pieces 111e.

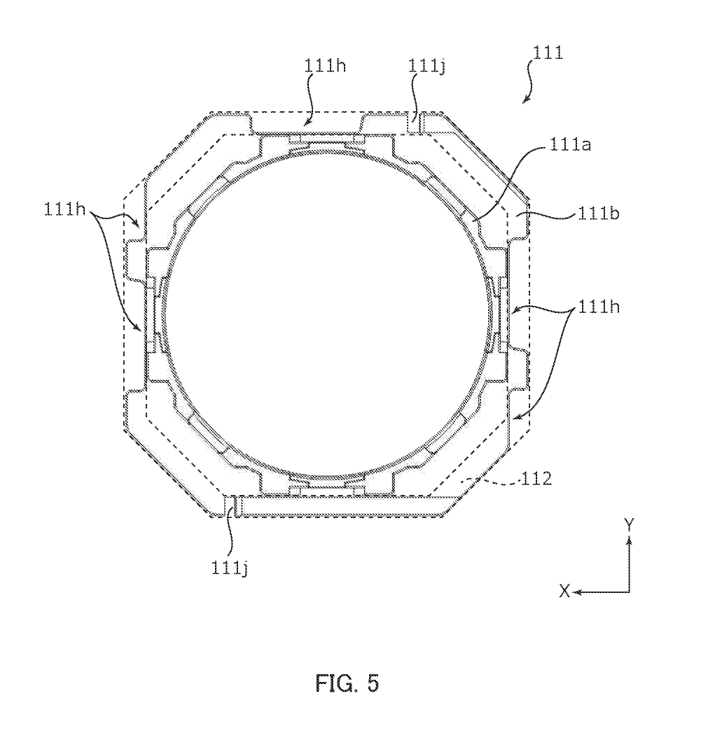

The upper portion of lens housing 111a (portion on the light reception side in the optical-axis direction with respect to flange portion 111b) has an octagonal shape as a whole. The upper portion of lens housing 111a bulges radially outward in places (bulge-out portion 111f). The outer peripheral surfaces of bulge-out portions 111f come into contact with AF coil 112. That is, lens housing 111a makes contact with AF coil 112 in places, and is spaced apart from AF coil 112 in the other places (see FIG. 5).

The lower portion of lens housing 111a (portion on the image formation side in the optical-axis direction with respect to flange portion 111b) has a cylindrical shape as a whole. The lower portion of lens housing 111a protrudes radially outward at four places of the lower portion that are point-symmetrical with respect to the optical axis (positioning pieces 111g). Lens holder 111 is positioned to base 121 by positioning pieces 111g. The lower portion of lens housing 111a is fit loosely in opening 121a of base 121.

Flange portion 111b has a shape corresponding to the shape of AF coil 112, that is, substantially has an octagonal shape in plan view. Flange portion 111b has a plurality of cutouts 111h and 111j. This results in weight reduction of lens holder 111. The ends of AF coil 112 are pulled out from two cutouts 111j of these cutouts toward base 121 (on the image formation side in the optical-axis direction) (hereinafter referred to as “coil pull-out portions 111j”).

Lower elastic supporting part 132 is fixed to undersurface 111k of flange portion 111b (hereinafter referred to as “lower-spring fixing portion 111k”). Lower-spring fixing portion 111k includes positioning piece 111m and positioning boss 111n each protruding toward base 121. Upper elastic supporting part 131 is positioned by positioning piece 111m and positioning boss 111n.

AF coil 112 is an air-core coil to be energized during focusing. AF coil 112 is wound in an octagonal shape in plan view. AF coil 112 is placed on flange portion 111b of lens holder 111, and comes into contact with bulge-out portions 111f. The ends of AF coil 112 are pulled out via coil pull-out portions 111j of lens holder 111 toward the base, and are electrically connected to tying parts 132d of lower elastic supporting part 132.

AF coil 112 is preferably formed using a copper clad aluminum wire that is an aluminum wire covered with copper. This makes it possible to achieve weight reduction in comparison with cases where AF coil 112 is formed using a copper wire.

Base 121 is a square member in plan view, and has opening 121a having a shape corresponding to the lower portion of lens holder 111. In camera module A, an image capturing part (not illustrated) is disposed on the image formation side of base 121 in the optical-axis direction.

Lower elastic supporting part 132 is fixed to four corners 121b inside base 111b (hereinafter referred to as “lower-spring fixing portions 121b”). Lower-spring fixing portions 121b each include positioning boss 121c protruding toward lens holder 111 (on the light reception side in the optical-axis direction). Lower elastic supporting part 132 is positioned by positioning bosses 121c.

Terminal metal fixtures 121d are disposed near two lower-spring fixing portions 12lb. The one ends of terminal metal fixtures 121d are electrically connected to lower elastic supporting part 132, and the other ends are to a power-source line (not illustrated) of an image sensor board (not illustrated).

Base 121 includes, at its peripheral surface, yoke attaching pieces 121e and 121f on which yoke 123 is placed. Yoke 123 is positioned by yoke attaching pieces 121e. Yoke 123 is fixed, for example, adhesively to yoke attaching pieces 121e and 121f while being placed on yoke attaching pieces 121e and 121f.

Four corners 121g at the peripheral edge of base 121 protrude toward lens holder 111 (hereinafter referred to as “insertion pieces 121g”). The trunk of insertion piece 121g is dented inward, and the top portion of insertion piece 121g projects outward.

AF magnet part 122 is composed of four cuboid permanent magnets 122A to 122D (hereinafter referred to as “AF magnets 122A to 122D”). It is preferable that AF magnets 122A to 122D each have a thickness (radial width) of 0.35 mm or smaller.

AF magnets 122A to 122D are magnetized such that magnetic fields radially traversing AF coil 112 are formed at AF coil 112. For example, permanent magnets 122A to 122D are magnetized such that the inner periphery sides and the outer periphery sides of permanent magnets 122A to 122D are set to N- and S-poles, respectively. The AF voice coil motor is composed of AF magnets 122A to 122D and AF coil 112.

Yoke 123 holds AF magnets 122A to 122D, and forms a magnetic circuit together with AF magnets 122A to 122D. Yoke 123 is formed by raising of a plate material made of a magnetic material. Preferably, yoke 123 is formed from a cold rolled steel plate. Preferably, the plate thickness of yoke 123 is 0.1 mm or smaller (for example, 0.08 mm). By forming yoke 123 from the cold rolled steel plate, the mechanical strength of yoke 123 as the casing of lens driving device 1 is ensured even when the plate thickness of yoke 123 is from 0.05 mm to 0.1 mm

Yoke 123 includes side frame 123a with a quadrangular shape, and top frame 123b projecting inward from the upper edge of side frame 123a.

AF magnets 122A to 122D are fixed, for example, adhesively to side frame 123a. The lower portions of two side frames 123a extending along the X direction each include protruding pieces 123c protruding toward base 121 (on the image formation side in the optical-axis direction).

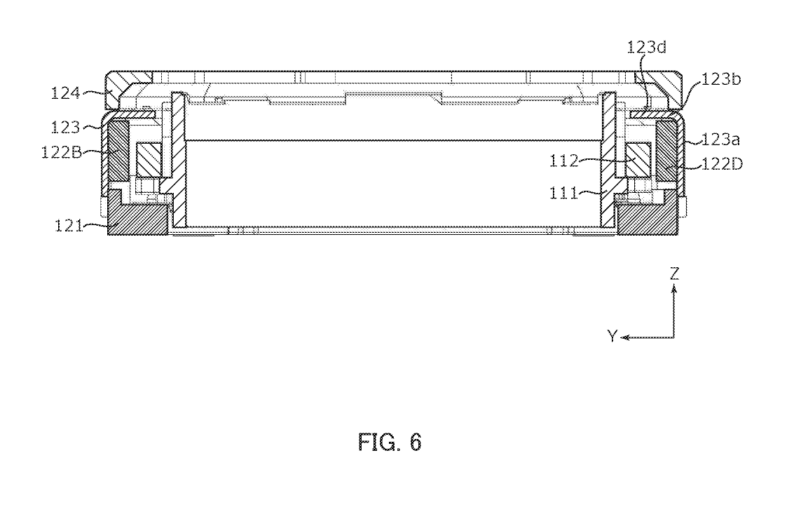

Top frame 123b has fixing holes (whose reference numeral is omitted) in which fixing bosses 124b of cover 123 are to be inserted. Cover 124 is fixed to top frame 123b by welding. The upper surfaces of AF magnets 122A to 122D (surfaces on the light reception side in the optical-axis direction) face the undersurface (surface on the image formation side in the optical-axis direction) of top frame 123b (see FIG. 6).

Yoke 123 has eaves portions 123d projecting over AF coil 122A to 122D from portions of top frame 123b other than the four corners of top frame 123b. The lengths of eaves portions 123d are smaller than those of AF magnets 122A to 122D, respectively. The lengths of eaves portions 123d are preferably 40% of the lengths of AF magnets 122A to 122D, respectively. In a case where eaves portions 123d are each formed to have a longitudinal extension corresponding to a longitudinal extension between both ends of each of AF magnets 122A to 122D, the driving force increases, but the weight of yoke 123 becomes heavier for that longitudinal extension. In the present embodiment, the lengths of eaves portions 123d are optimized from a viewpoint of power-to-weight ratio.

When iron yoke 123 is one of components, the weight of the yoke accounts for a high proportion of the total weight, and accordingly it is effective to reduce the weight of the yoke in order to achieve weight reduction. It is, however, not easy to reduce the weight of the yoke while securing the mechanical strength required for the yoke as a casing and the driving force required for driving a lens. In the present embodiment, the area of top frame 123b of yoke 123 is minimized as long as the required driving force can be efficiently obtained and cover 124 can be welded to yoke 123, and in addition, the opposite yoke portion is omitted. This makes it possible to achieve remarkable weight reduction in comparison with the traditional yokes (see PTLS 1 and 2).

In addition, when yoke 123 is attached to base 121, protruding pieces 123c are engaged with yoke attaching pieces 121e of base 121. Moreover, insertion pieces 121g of base 123 are disposed to be located deep inside yoke 123. The top portions 121g of insertion pieces make contact with the four corners of yoke 123, so that the space for resin application is defined between insertion pieces 121g and yoke 123. This makes it possible to shorten the skirt of yoke 123, so that the weight reduction can be achieved.

Since eaves portions 123d are each formed as small as possible and in addition the opposite yoke portion is omitted, yoke 123 cannot be said to have an effective structure for obtaining a great driving force. However, the weight of yoke 123 is significantly reduced, and therefore, yoke 123, when considered from the viewpoint of power-to-weight ratio, is excellent compared to the traditional yokes. In addition, the weight of AF movable part 11 including lens holder 111, AF coil 112, and/or the like, is optimally reduced, so that driving characteristics equal or superior to traditional driving characteristics can be secured with a small driving force.

Cover 124 is a square lid in plan view. Cover 124 is preferably made of a resin material with high mechanical strength, such as polycarbonate or the like. Cover 124 has opening 124a having a shape corresponding to lens housing 111a of lens holder 111. Lens part 2 faces outside from this opening 124a. Cover 124 has fixing bosses 124b for fixing upper spring 131 at the four corners of its undersurface. In the meanwhile, FIGS. 3 and 4 illustrate caulked fixing bosses 124b; however, fixing bosses 124b before assembly can be inserted in the fixing holes (whose reference numeral is omitted) of yoke fixing portions 131b of upper spring 131 and in the fixing holes (whose reference numeral is omitted) of top frame 123b of yoke 123.

Upper elastic supporting part 131 is, for example, a plate spring made of beryllium copper, nickel copper, stainless steel, or the like (hereinafter referred to as “upper spring 131”). Upper spring 131 elastically supports AF movable part 11 (lens holder 111) with respect to AF fixing part 12 (yoke 123 and cover 124). Upper spring 131 is sandwiched between yoke 123 and cover 124 when yoke 123 is attached to cover 124.

Upper spring 131 is shaped by being punched out from one sheet metal, for example. Upper spring 131 includes lens-holder holding portion 131a, yoke fixing portions 131b, and arm portions 131c. Lens-holder holding portion 131a has a shape conforming to upper-spring fixing portion 111d of lens holder 111, and has cutouts at positions corresponding to positioning pieces 111e. Arm portions 131c each connect yoke fixing portion 131b to lens-holder holding portion 131a. Arm portions 13c each have a curved shape, and elastically deform when AF movable part 11 moves.

Cutout portions (whose reference numeral is omitted) of lens-holder holding portion 131a are engaged with positioning pieces 111e of lens holder 111, so that upper spring 131 is positioned and fixed to lens holder 111. Although adjacent yoke fixing portions 131b have traditionally been coupled with each other by a coupling portion, upper spring 131 has a lightweight structure in which such a coupling potion is omitted.

Fixing bosses 124b of cover 124 are inserted in the fixing holes (whose reference numeral is omitted) of yoke fixing portions 131b and in the fixing holes (whose reference numeral is omitted) of yoke 123, so that upper spring 131 is positioned, and is then fixed by thermal caulking. When AF movable part 11 moves in the optical-axis direction, lens-holder holding portion 131a is displaced along with AF movable part 11.

Lower elastic supporting part 132 is, for example, composed of two plate springs made of beryllium copper, nickel copper, stainless steel, or the like (hereinafter referred to as “lower springs 132A and 132B”). Lower springs 132A and 132B elastically support AF movable part 11 (lens holder 111) with respect to AF fixing part 12 (base 121).

Lower springs 132A and 132B are shaped by being punched out from one sheet metal, for example. Since lower springs 132A and 132B have substantially the same construction as each other, descriptions for lower spring 132A are given.

Lower spring 132A includes lens-holder holding portion 132a, base fixing portions 132b, and arm portions 132c. Lens-holder holding portion 132a has the shape of a circular arc conforming to the outer peripheral surface of the lower portion of lens housing 111a of lens holder 111. Arm portions 132c couple base fixing portions 132b with lens-holder holding portion 132a. Arm portions 131c each partly have a winding road shape, and elastically deform when AF movable part 11 moves.

Positioning piece 111m or positioning boss 111n of lens holder 111 are inserted in a fixing hole (whose reference numeral is omitted) of lens-holder holding portion 132a, so that lower spring 132A is positioned and fixed to lens holder 111.

Lower spring 132A has tying part 132d at an end (near one of base fixing portions 132b) of lens-holder holding portion 132a. Tying part 132d is electrically connected to the end of AF coil 112 pulled out from coil pull-out portion 111j of lens holder 111.

Lower spring 132A includes terminal connecting portion 132e extending from one of base fixing portions 132b. Terminal connecting portion 132e is electrically connected to terminal metal fixture 121d disposed to base 121. Electricity is supplied to AF coil 112 via lower springs 132A and 132B.

Positioning bosses 121c of base 121 are inserted in the fixing holes (whose reference numeral is omitted) of base fixing portions 132b, so that lower spring 132A is positioned and fixed to base 121. When AF movable part 11 moves in the optical-axis direction, lens-holder holding portion 132a is displaced along with AF movable part 11.

When automatic focusing is performed in lens driving device 1, AF coil 112 is energized. When AF coil 112 is energized, a Lorentz force is generated at AF coil 112 by interaction between the magnetic field of AF magnet part 122 and the current flowing through AF coil 112. The direction of the Lorentz force is the direction (the Z direction) orthogonal to the direction of the magnetic field generated by AF magnet part 122 and the direction of the current flowing through AF coil 112. Since AF magnet part 122 is fixed, a reactive force acts on AF coil 112. With this reactive force serving as the driving force of the AF voice coil motor, AF movable part 11 including AF coil 112 moves in the optical-axis direction, so that focusing is performed.

In an non-energization state where automatic focusing is not carried out, AF movable part 11 is held suspended between an infinity position and a macro position (hereinafter referred to as “reference state”) for example by upper elastic supporting part 131 and lower elastic supporting part 132. That is, AF movable part 11 is elastically supported to be displaceable on both sides in the Z direction while being positioned with respect to AF fixing part 12 by upper elastic supporting part 131 and lower elastic supporting part 132. When focusing is performed, the direction of current is controlled depending on toward which side of the macro position side and the infinity position side AF movable part 11 is to be moved from the reference state. In addition, the magnitude of current is controlled depending on the moving distance of AF movable part 11.

As described above, lens driving device 1 includes AF coil 112 to be disposed at a periphery of lens part 2, AF magnets 122A to 122D to be disposed such that AF magnets 122A to 122D are radially spaced apart from AF coil 112 and surround four sides of the AF coil, and yoke 123 for forming a magnetic circuit together with AF magnets 122A to 122D, lens driving device 1 being configured to perform automatic focusing by moving AF movable part 11 including AF coil 112 in the optical-axis direction with respect to AF fixing part 12 including AF magnets 122A to 122D and yoke 123 by utilizing the driving force of the voice coil motor composed of AF coil 112 and AF magnets 122A to 122D. Yoke 123 includes side frame 123a to which AF magnets 122A to 122D are fixed, top frame 123b projecting inward from the upper edge of side frame 123a, and eaves portions 123d projecting over AF coil 112 from the portions of top frame 123b other than the four corners of top frame 123b.

According to lens driving device 1, the weight of the yoke is reduced remarkably in comparison with traditional yokes while mechanical strength required for the yoke as a casing and a thrust required for driving a lens are ensured. Lens driving device 1 is a lightweight lens driving device having a high power-to-weight ratio, and is thus applicable also to a wearable terminal. For example, when the size of lens driving device 1 is 8.5 mm square, the total weight can be 0.16 g or less (1/2 of the weight of an existing lens driving device or less), and the height can be 2.5 mm or less.

While the invention made by the present inventor has been specifically described based on the preferred embodiments, it is not intended to limit the present invention to the above-mentioned preferred embodiments but the present invention may be further modified within the scope and spirit of the invention defined by the appended claims.

For example, although in the descriptions given for the embodiment, a wearable terminal is mentioned as an example of a camera-mounted device having camera module A, the present invention is applicable to a camera-mounted device that is an information apparatus or a transport apparatus. The camera-mounted device that is an information apparatus is an information apparatus including a camera module and a control section that processes image information obtained with the camera module, and examples of such a camera-mounted device include a smartphone, a camera-equipped mobile phone, a note-type personal computer, a tablet terminal, a mobile game machine, a web camera, and a camera-equipped in-vehicle apparatus (for example, a rear-view monitor apparatus or a drive recorder apparatus). In addition, the camera-mounted device that is a transport apparatus is a transport apparatus including a camera module and a control section that processes an image obtained with the camera module, and examples of such a camera-mounted device include an automobile.

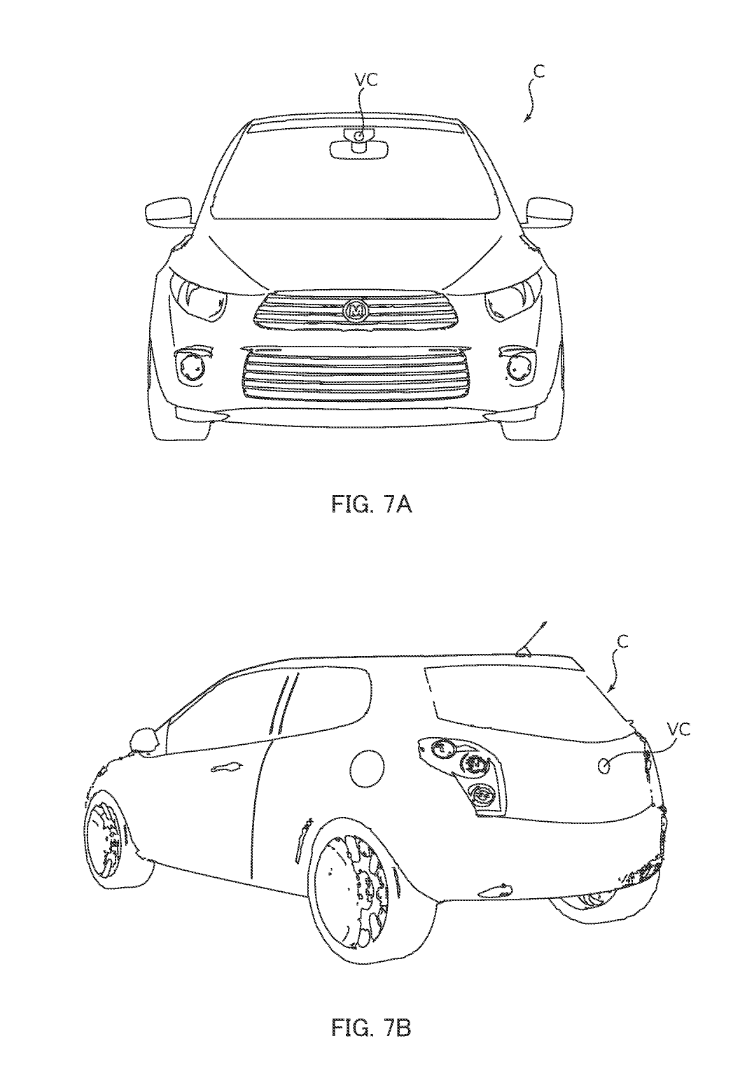

FIGS. 7A and 7B illustrate automobile C serving as a camera-mounted device in which an in-vehicle camera module VC (Vehicle Camera) is mounted. FIG. 7A is a front view of vehicle C and FIG. 7B is a rear perspective view of vehicle C. In automobile C, camera module A described in the embodiment is mounted as in-vehicle camera module VC. As illustrated in FIGS. 7A and 7B, in-vehicle camera module VC may, for example, be attached to the windshield so as to face forward, or to the rear gate so as to face backward. Onboard camera module VC is used for rear monitoring, drive recording, collision avoidance control, automatic drive control, and the like.

The embodiment disclosed herein is merely an exemplification in every respect and should not be considered as limitative. The scope of the present invention is specified by the following claims, not by the above-mentioned description. The scope of the present invention is intended to include all modifications in so far as they are within the scope of the appended claims or the equivalents thereof.

This application is entitled to and claims the benefit of Japanese Patent Application No. 2015-118287 dated Jun. 11, 2015, the disclosure of which including the specification, drawings and abstract is incorporated herein by reference in its entirety.

### REFERENCE SIGNS LIST

1 Lens driving device
2 Lens part
11 AF movable part (autofocus movable part)
111 Lens holder
112 AF coil (auto-focusing coil)
12 AF fixing part (autofocus fixing part)
121 Base
122 AF magnet part
122A to 122D Permanent magnet, AF magnet
123 Yoke
123a Side frame
123b Top frame
123d Eaves portion
124 Cover
13 Elastic supporting part
131 Upper elastic supporting part, Upper spring
132 Lower elastic supporting part
132A, 132B Lower spring
W Wearable terminal (camera-mounted device)
A Camera module

1. A lens driving device comprising:
an auto-focusing coil to be disposed at a periphery of a lens part;
one or more auto-focusing magnets to be disposed such that the one or more auto-focusing magnets are radially spaced apart from the auto-focusing coil and surround four sides of the auto-focusing coil; and
a yoke for forming a magnetic circuit together with the one or more auto-focusing magnets, the lens driving device being configured to automatically perform focusing by moving an autofocus movable part with respect to an autofocus fixing part in an optical-axis direction by utilizing a driving force of a voice coil motor, the autofocus fixing part including the one or more auto-focusing magnets and the yoke, the autofocus movable part including the auto-focusing coil, the voice coil motor being composed of the auto-focusing coil and the one or more auto-focusing magnets, wherein:
the yoke includes a side frame to which the one or more auto-focusing magnets are fixed, a top frame projecting inward from an upper edge of the side frame, and an eaves portion projecting over the auto-focusing coil from a portion of the top frame other than four corners of the top frame.

2. The lens driving device according to claim 1, wherein:
the eaves portion has a length smaller than a length of a corresponding one of the one or more auto-focusing magnets.

3. The lens driving device according to claim 1, wherein:
the yoke is formed from cold-rolled steel.

4. The lens driving device according to claim 1, wherein:
the yoke has a plate thickness of from 0.05 mm to 0.1 mm.

5. A camera module comprising:
the lens driving device according to claim 1;
the lens part to be mounted to the autofocus movable part; and
an image capturing part configured to capture a subject image imaged by the lens part.

6. A camera-mounted device that is an information device or a transporting device, the camera-mounted device comprising:
the camera module according to claim 5.
